(19) United States
(12) Patent Application Publication
(10) Pub. No.: US 2026/0362549 A1
(43) Pub. Date: Nov. 12, 2026

(54) SYSTEMS AND METHODS FOR INFORMATION EXCHANGE VIA WEARABLE DEVICES

(71) Applicant: Robert Washington, Wilmington, NC (US)

(72) Inventor: Robert Washington, Wilmington, NC (US)

(21) Appl. No.: 19/259,462

(22) Filed: Jul. 3, 2025

Related U.S. Application Data
(63) Continuation-in-part of application No. 19/205,032, filed on May 12, 2025, now abandoned.

(51) Int. Cl. H04W 84/18; H04M 1/72412

(52) U.S. Cl. CPC H04W 84/18; H04M 1/72412

(57) ABSTRACT

A system and method for context-aware exchange of personal or professional information using wearable devices. Each user is equipped with a wearable device, such as a ring, bracelet, watch, or necklace, capable of establishing a connection with another device through physical gestures or wireless communication protocols. A companion application allows users to create and manage segmented profiles containing personal and professional data. Upon detecting a connection event, the system filters and transmits selected information based on user-defined permissions and contextual settings. Users retain full control over what data is shared, with options to restrict access, set time-based visibility, and designate sharing modes. The system facilitates seamless, secure, and socially intuitive interactions in both personal and professional environments.

### RELATED APPLICATION

This application is a continuation in part of US non-provisional application Ser. No. 19/205,032 filed May 12, 2025 which is incorporated herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### TECHNICAL FIELD

The present invention relates generally to information exchange systems and, more particularly, to systems and methods for exchanging user information via wearable devices using physical gestures or wireless connectivity.

### BACKGROUND

The exchange of personal and professional contact information has long relied on manual and often awkward social interactions. In traditional settings, individuals would verbally share their phone numbers, write them down on paper, or later search for each other on social media platforms. These methods are not only time-consuming but also susceptible to errors and miscommunications. In many cases, the discomfort or social hesitation involved in asking for someone's information acts as a deterrent, limiting opportunities for personal connection, networking, or collaboration.

Recently, various technologies have attempted to streamline these interactions. Business cards provided a tangible means of contact sharing, later giving way to digital contact cards, email exchanges, and social media connections. More recently, smartphones and QR code-based systems have become commonplace, allowing for faster exchanges. However, these technologies still require overt actions, such as asking someone to unlock their phone, scan a code, or initiate a connection through a third-party app, which can be intrusive or awkward in socially nuanced environments.

Another issue with current methods is the lack of contextual control over the type and amount of information shared. Users often have to decide in real time how much to disclose and to whom, which can create tension or lead to over-sharing. For example, someone might hesitate to share their full contact card when they only wish to exchange professional details. Similarly, in dating environments, people are often reluctant to share phone numbers or social media profiles before establishing a basic level of trust or compatibility.

Wearable technology has introduced new opportunities for passive and context-aware interaction, but these tools have yet to be widely adopted for the purpose of contact exchange. Most wearable devices focus on health tracking or notifications and do not facilitate social interactions beyond simple messaging functions. As a result, the potential for leveraging wearable tech in interpersonal contexts remains largely untapped.

The current state of the industry reflects a growing demand for simple, discreet, and user-controlled methods of connecting with others. There is a clear gap between the capabilities of existing tools and the dynamic social needs of users, particularly in environments where first impressions and discretion are paramount.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a device, a system and method for exchanging user-specific information through wearable technology in a way that is seamless, context-aware, and user-controlled. This embodiments enable users to connect and share personal or professional data using a wearable device, such as a ring, bracelet, necklace, or watch, in conjunction with a supporting software application. The system overcomes limitations in the current state of the art by allowing discreet and purposeful data sharing via physical gestures or wireless communication protocols, while providing granular control over privacy and data visibility.

The wearable device is configured to initiate a connection through proximity-based wireless communication, such as near-field communication (NFC), Bluetooth, or a similar short-range protocol. In some embodiments, a connection is triggered by a physical gesture, such as tapping two devices together. This interaction eliminates the need for cumbersome, awkward, or socially uncomfortable steps typically required when exchanging personal information using smartphones or business cards. The tactile nature of the gesture also reinforces the intentionality of the interaction, increasing trust between users.

Each wearable device communicates with a dedicated mobile application that serves as the user's control center. Through the application, users input and manage data that may include personal contact details, professional credentials, dating history, lifestyle preferences, or job aspirations. This data is categorized into two primary modes: personal and professional. The user can select which profile is active at the time of connection, ensuring that only relevant information is shared based on the interaction context.

A key advantage of the embodiments lies in its dynamic permission system. Users are empowered to determine in advance which fields of information are visible under each context. For instance, in a professional setting, the user may opt to share only their name, title, and LinkedIn profile, while hiding phone numbers and personal interests. In a social setting, they may instead allow the exchange of dating preferences or food likes, without revealing employment history. This selective sharing is not available in traditional systems like contact cards or static digital profiles, which offer little flexibility during interactions.

The mobile application enables configuration of default sharing settings as well as exceptions through whitelists and blacklists. Users can allow data to be shared only with certain individuals or block data from being sent to particular contacts. Furthermore, the app supports time-bound permissions-allowing users to share information temporarily, such as for 24 hours-after which access automatically expires. These controls give users unprecedented command over their digital identity and reduce the risk of data misuse.

The invention also includes a connection logging mechanism. After a successful connection, users may view a history of previous interactions, including the date and type of data shared. This function is optional and user-configurable, offering convenience for future follow-ups or networking without compromising user privacy. In contrast, conventional contact-sharing mechanisms typically do not provide a transparent log of shared information or enable post-connection data review.

Security is addressed through encryption protocols integrated into the data transmission and storage layers. The wearable device and mobile application both implement end-to-end encryption, ensuring that user data is protected from interception during communication between devices. This improves over prior art systems, such as QR code-based tools or public profile URLs, which may expose user data to unauthorized access during transmission or storage.

In terms of hardware, the wearable device includes a housing designed for comfort and continuous wear. The device may be worn as a ring, bracelet, wristwatch, or necklace, making it both discreet and accessible. The internal hardware includes a wireless communication module, memory for data storage, and a processor configured to execute transmission logic and permission validation. Some embodiments may include a small screen for displaying connection confirmation or mode status, further enhancing usability.

When a connection event is detected, the wearable device and app operate together to verify compatibility and context. If the user has specified a professional mode, only professional profile data is made available for transmission. If the user has designated a personal mode, then the application restricts shared data accordingly. This automated filtering improves upon prior systems that rely on manual selection during each interaction, reducing delays and the potential for accidental over-sharing.

The invention allows for device pairing confirmation mechanisms, such as vibration feedback, LED indicators, or UI confirmation on the mobile application. This feedback loop assures users that the exchange was successful and that the correct data was transmitted. Prior solutions rarely provide such real-time confirmation, often requiring users to verify success manually through trial and error.

In one embodiment, the system supports fallback methods such as QR code scanning or app-to-app linking for devices that do not support proximity pairing. This ensures cross-compatibility and greater adoption. Even in these scenarios, the same permission rules and privacy filters apply, preserving the core benefits of the invention across platforms.

The present system's advantages over the prior art are numerous. It eliminates the awkwardness of requesting someone's contact information, removes the need to hand over a physical object or phone, and empowers users with fine-grained control over what they share, with whom, and when. These benefits are particularly valuable in contexts such as professional networking events, dating venues, trade shows, and spontaneous social encounters.

Unlike static contact exchange tools, the invention adapts to the environment and gives users real-time control without requiring them to make disruptive changes mid-conversation. It promotes intentional interaction through intuitive gestures and contextual awareness, reducing friction and increasing the likelihood of meaningful connections.

Furthermore, the invention serves not only as a personal utility but also as a platform for secure digital identity exchange. In a world where privacy concerns and digital overload are growing, users demand systems that are both easy to use and protective of their data. This system satisfies both criteria, giving users confidence in each interaction while streamlining communication.

In summary, the invention provides a comprehensive solution that addresses the shortcomings of traditional contact-sharing systems and prior wearable technologies. By combining user-friendly wearable devices, a robust mobile application, wireless communication, privacy-by-design principles, and configurable interaction contexts, the invention redefines how individuals connect and share information in both social and professional settings.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a system architecture diagram of the network infrastructure, according to some embodiments;

FIG. 2 illustrates a block diagram of the application program in communication with the computing system, according to some embodiments; and

FIG. 3 illustrates a flowchart of a method for information exchange via wearable devices, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

It is further noted that the claims may be drafted to exclude any element which may be optional. As such, this statement is intended to serve as antecedent basis for use of such exclusive terminology as “solely”, “only” and the like in connection with the recitation of claim elements, or the use of a “negative” limitation.

In general, the embodiments provided herein relate to a wearable device configured for physical or wireless interaction with another similar device. The wearable may take various ergonomic forms, including a ring, bracelet, necklace, watch, or clip-on accessory, designed for continuous use and social acceptability. Unlike smartphones or external objects, the form factor enables immediate access and convenience during spontaneous interactions.

Each wearable device contains a communication module, which may include near-field communication (NFC), Bluetooth, ultra-wideband (UWB), or other short-range wireless protocols. The communication module detects proximity or physical contact between devices and facilitates the secure exchange of data between them. This component enables the tactile or ambient initiation of information transfer, reducing reliance on overt actions like scanning codes or typing details.

The device further comprises a processor and memory unit, responsible for executing instructions and managing local data storage. The memory may store a simplified version of the user's data profile, including tags or identifiers associated with specific types of content, such as name, email, job title, dating preferences, or hobbies. The processor is programmed to determine, based on contextual cues or app directives, what information may be transmitted during a connection event.

Central to the invention is the mobile or wearable-compatible application, which interfaces with the wearable device via a secure communication channel. The application allows users to input, update, organize, and classify their information into distinct profiles, primarily a personal profile and a professional profile. Each profile may include multiple data fields with user-definable visibility settings.

A distinguishing feature of the invention is the contextual sharing mode, which enables users to select whether the information shared during a connection falls under a personal or professional context. This toggle can be set manually or automatically based on the device's location, calendar events, or behavioral patterns. The system then filters the data accordingly, ensuring only appropriate fields are transmitted.

Another key inventive aspect is the permission management system, which gives users granular control over data visibility. Users may enable or disable specific fields for sharing, define what data is available to everyone versus only to approved contacts, and apply time-based conditions for access. This structure eliminates the binary “share or don't share” limitation found in prior systems and enhances user agency.

The invention also supports whitelisting and blacklisting, allowing users to predefine which individuals or device IDs are authorized to receive certain types of data. A whitelist enables immediate data transfer with trusted devices, while a blacklist can automatically prevent the initiation of a connection or data release, thereby providing a security-enhancing gatekeeping layer.

In some embodiments, the wearable device may include haptic feedback, LED indicators, or small displays to notify users of connection status, sharing success, or the active mode. These real-time signals offer reassurance during interactions and reduce ambiguity about whether data was actually exchanged.

The system is further equipped with encryption protocols to protect data during transmission and storage. End-to-end encryption is applied to ensure that only the intended recipient device or app instance can decrypt and view the data. The encryption keys are managed securely through the application and updated periodically to prevent unauthorized access.

A notable inventive element is the connection event detector, which monitors for physical taps or proximity-based signals to trigger the sharing mechanism. This event handler is implemented either in hardware, such as tap sensors or accelerometers, or software, such as signal strength thresholding, depending on the design of the wearable. It enables naturalistic interactions and supports the invention's emphasis on social intuitiveness.

The data filtering engine within the mobile application dynamically evaluates the sharing rules each time a connection is initiated. This engine checks the active profile, the permission levels, and any exceptions, such as blocked users or expired visibility periods, before assembling the appropriate data payload. This automated control reduces cognitive load for the user and ensures consistent application of their preferences.

Users may also benefit from a connection log feature, which stores metadata about previous interactions, such as the date, time, location if permitted, and nature of the data shared. This history can be used to reinitiate contact, audit one's sharing behavior, or simply serve as a digital memory aid. The logging function is entirely user-controlled and can be disabled for users who prefer complete anonymity.

The invention optionally includes backup and cloud synchronization features. All profile data, permissions, and history logs may be securely backed up and synced across devices, allowing users to manage their information from multiple endpoints. This ensures data resilience and continuity, especially when transitioning to a new wearable or phone.

For compatibility, the system supports fallback data exchange methods, such as dynamic QR codes or short-lived link generation, allowing users to connect even when one party lacks a compatible wearable device. These alternative methods still respect the core permission framework, maintaining user control over data exposure.

In another embodiment, the system includes a social discovery layer, enabling users to opt into a discoverable mode where nearby compatible users are visible in the app. Even in this mode, user information remains protected and filtered until a connection request is accepted and the sharing criteria are met. This expands the utility of the invention beyond one-to-one interactions.

The invention may also include a temporary access feature, where a user can grant another user limited-time access to a broader dataset. This is useful in event settings, follow-up interactions, or group environments where continued engagement is desired without requiring permanent contact details to be exchanged.

Finally, the system may provide analytics and usage summaries, giving users insight into how often they connect, what types of data are most frequently shared, and which settings are most commonly used. These insights can guide users in refining their sharing strategies, enhancing both privacy and engagement.

In one embodiment, the invention provides a dual-profile system comprising a personal account and a professional account, each of which may be independently configured by the user. These two modes are fundamental to the context-aware functionality of the invention, enabling users to dynamically control which aspects of their identity are presented during a given interaction. The ability to toggle between modes reduces the likelihood of accidental over-sharing and preserves the user's intent in diverse social or professional scenarios.

The user may switch between personal and professional accounts through a user interface presented in the mobile application or on the wearable device itself, if equipped with a display or control surface. The switch may be manual—such as toggling a setting labeled “Personal” or “Professional”—or may be automated based on contextual triggers. For example, the device may detect a calendar entry labeled “Networking Event” and activate the professional profile automatically or may infer a social setting based on GPS coordinates or time of day.

The personal account is designed to store and share information that is socially or romantically relevant. This may include the user's dating preferences, relationship status, hobbies, favorite music, social media handles, lifestyle goals, or even a curated bio intended to foster friendship or romantic connection. The personal profile is flexible and user-customizable, allowing the user to decide which fields are private, shareable, or only visible after a reciprocal connection has been made.

Conversely, the professional account is tailored for business or career-oriented exchanges. This profile may include the user's name, title, employer, LinkedIn profile, educational background, key skills, certifications, and career aspirations. The profile may also include a digital business card format or vCard download for easy integration with third-party contact systems. Importantly, the professional account is isolated from any personal or dating-related information, thereby ensuring that only appropriate data is presented during business interactions.

In some embodiments, each account is associated with a distinct set of permissions and visibility rules. For instance, a user may allow broad sharing of their name and title in professional mode, while reserving social media links or messaging access to verified connections in personal mode. This dual-layer permission model helps users project the right identity in each context without needing to constantly edit their profile or second-guess what information will be transmitted.

The system further provides visual indicators to confirm which mode is currently active. When using a mobile device, the active mode may be displayed prominently at the top of the screen. On wearables equipped with displays or LED feedback, distinct colors, icons, or vibration patterns may be used to signal the current profile status. This feedback helps prevent unintentional data sharing from the wrong profile and reinforces the user's sense of control.

Additionally, users may define mode-specific behaviors for certain contacts or events. For example, a user might allow certain friends or mutual contacts to see elements of both profiles and might configure the device to automatically revert to professional mode during business hours. These rules are managed through an intuitive settings interface and can be changed at any time, ensuring flexibility and adaptability as the user's preferences evolve.

In one embodiment, the invention provides a dual-profile system comprising a personal account and a professional account, each of which may be independently configured by the user. These two modes are fundamental to the context-aware functionality of the invention, enabling users to dynamically control which aspects of their identity are presented during a given interaction. The ability to toggle between modes reduces the likelihood of accidental over-sharing and preserves the user's intent in diverse social or professional scenarios.

The user may switch between personal and professional accounts through a user interface presented in the mobile application or on the wearable device itself, if equipped with a display or control surface. The switch may be manual—such as toggling a setting labeled “Personal” or “Professional”—or may be automated based on contextual triggers. For example, the device may detect a calendar entry labeled “Networking Event” and activate the professional profile automatically or may infer a social setting based on GPS coordinates or time of day.

The personal account is designed to store and share information that is socially or romantically relevant. This may include the user's dating preferences, relationship status, hobbies, favorite music, social media handles, lifestyle goals, or even a curated bio intended to foster friendship or romantic connection. The personal profile is flexible and user-customizable, allowing the user to decide which fields are private, shareable, or only visible after a reciprocal connection has been made.

Conversely, the professional account is tailored for business or career-oriented exchanges. This profile may include the user's name, title, employer, LinkedIn profile, educational background, key skills, certifications, and career aspirations. The profile may also include a digital business card format or vCard download for easy integration with third-party contact systems. Importantly, the professional account is isolated from any personal or dating-related information, thereby ensuring that only appropriate data is presented during business interactions.

In some embodiments, each account is associated with a distinct set of permissions and visibility rules. For instance, a user may allow broad sharing of their name and title in professional mode, while reserving social media links or messaging access to verified connections in personal mode. This dual-layer permission model helps users project the right identity in each context without needing to constantly edit their profile or second-guess what information will be transmitted.

The system further provides visual indicators to confirm which mode is currently active. When using a mobile device, the active mode may be displayed prominently at the top of the screen. On wearables equipped with displays or LED feedback, distinct colors, icons, or vibration patterns may be used to signal the current profile status. This feedback helps prevent unintentional data sharing from the wrong profile and reinforces the user's sense of control.

Additionally, users may define mode-specific behaviors for certain contacts or events. For example, a user might allow certain friends or mutual contacts to see elements of both profiles and might configure the device to automatically revert to professional mode during business hours. These rules are managed through an intuitive settings interface and can be changed at any time, ensuring flexibility and adaptability as the user's preferences evolve.

In one particular use-case, the invention may be used for silently communicating via haptic feedback provided on the device. This would allow, for example, military personnel to communicate silently with one another during an operation.

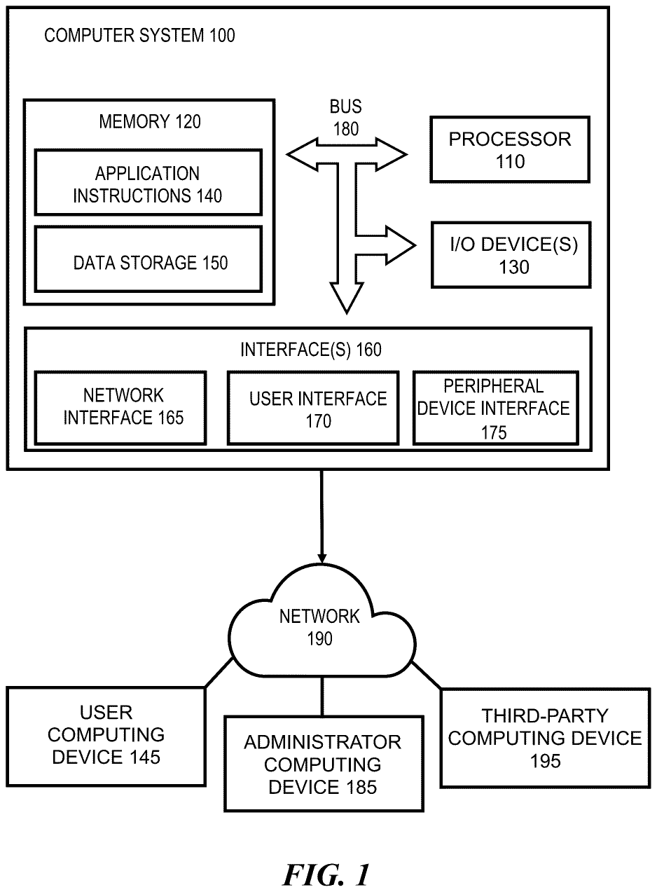

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

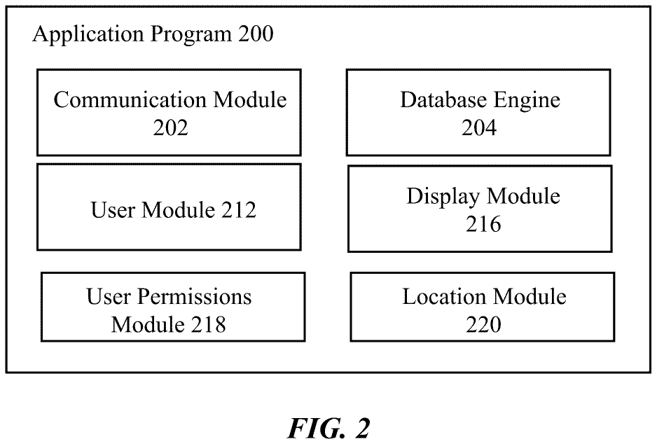

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a user module 212, a display module 216, a user permissions module 218, and a location module 220.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195. In some embodiments, the communication module 202 allows each user to transmit and receive information which may be used by the system.

The communication module 202 is responsible for establishing and managing connections between wearable devices and external systems such as paired mobile applications, cloud databases, or other users' devices. This module includes logic for handling both proximity-based wireless communication protocols, such as Bluetooth, NFC, and UWB, and fallback methods including QR code-based exchanges or secure web-based interfaces.

The communication module verifies device compatibility, manages encryption keys for secure data transfer, and supports real-time handshaking procedures that ensure data packets are exchanged only with authenticated recipients. It operates continuously in the background, using low-energy protocols to detect connection events and trigger profile data filtering and transmission according to the rules defined by the user permissions module.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations. The database engine 204 allows each user and module associated with the system to transmit and receive information stored in various databases.

The database engine 204 is responsible for managing all persistent data associated with the user's profiles, interaction history, and application preferences. It includes the schema definitions for the dual-profile system (personal and professional), along with structures for storing fields such as contact details, preferences, career data, and custom metadata.

The engine is optimized for secure and efficient data retrieval, supporting both on-device storage and cloud synchronization. It enforces access controls for each data element based on user-defined permissions, and logs transaction history, such as connection timestamps and the types of data shared. The database engine ensures consistency across user devices and prevents data leakage during transitions between sharing modes.

The user module 212 handles the creation, customization, and management of the user's digital identity within the application. It supports input for all profile data fields, validation routines for formatting (e.g., email or phone number formats), and profile segmentation between personal and professional modes.

This module also allows the user to create whitelists, blacklists, and temporary access configurations, ensuring that profile visibility is both intentional and adaptive. Additionally, the user module interfaces with the permissions engine to generate filtered data packages at runtime, which are transmitted during connection events. It acts as the logic center for assembling context-aware user information based on preferences and real-world cues.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 provides alerts to the user device which can be viewed and acknowledged by the user.

The display module 216 governs how information is visually presented to the user on both the mobile application and any display-capable wearable device. This includes graphical elements for viewing and editing profile information, managing visibility settings, and confirming successful device connections or transmissions.

In wearables equipped with a display, the module also supports visual indicators of current mode (e.g., personal vs. professional), incoming connection alerts, and user notifications. In mobile implementations, the module provides intuitive navigation between settings and profile content, including dynamic previews of what will be shared based on current permissions. This feedback layer enhances transparency and user confidence.

The user permissions module 218 is a critical component of the system's privacy architecture. It defines, stores, and enforces user-specific rules for data visibility and access. This includes which fields are visible in different sharing modes, who is authorized to receive information, and under what conditions data can be shared, such as time limits or geofencing constraints.

This module works in conjunction with the communication and user modules to ensure that only properly filtered data sets are assembled and transmitted. It supports context-dependent behaviors, such as automatically switching to a restricted mode during business hours or hiding sensitive fields unless explicitly authorized by the user. The permissions module ensures the platform remains user-centric and privacy-compliant.

The location module 220 tracks and interprets geospatial data to provide context-awareness within the application. It leverages GPS, Wi-Fi triangulation, or device-based location services to determine where the user is physically located and uses this information to influence data-sharing behavior. For example, it may trigger a switch to professional mode when the user is near a registered workplace or networking venue.

The module can also be used to restrict data sharing to specific regions or to prevent connections entirely in predefined locations. Additionally, the location data may be logged (with user consent) to enrich connection history or to support time-place filtering in analytics. The location module adds a dynamic layer of intelligence, allowing the system to adapt to the user's environment in real time.

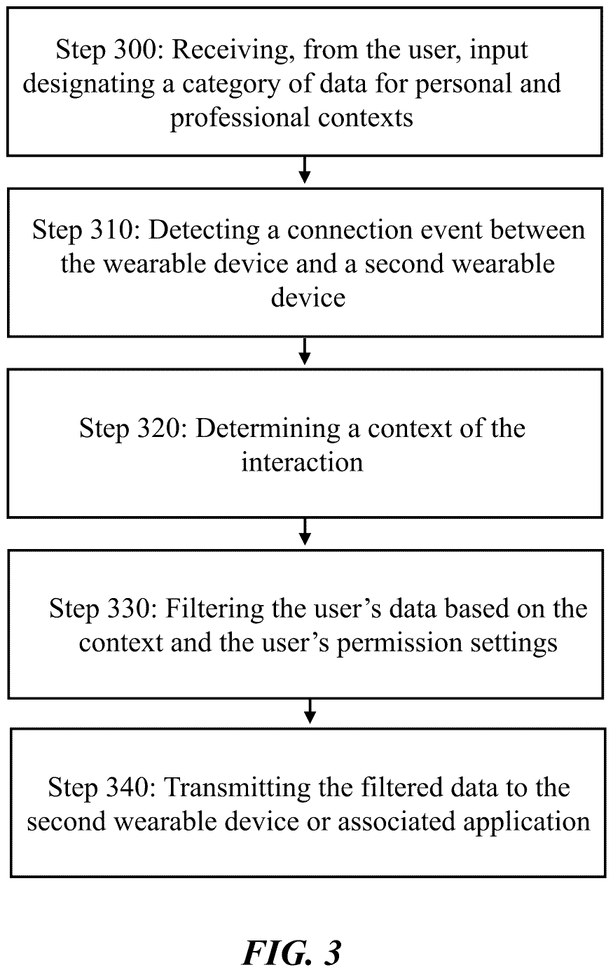

Referring now to FIG. 3, the method begins by providing a user with a wearable device configured for short-range wireless communication. The wearable may be embodied as a ring, bracelet, necklace, watch, or other form factor that enables continuous wear in both social and professional settings. The device contains internal components including a wireless communication module (e.g., NFC, Bluetooth), a processor, and memory for storing locally relevant profile metadata.

The device is paired with a mobile application or cloud service that enables user authentication and secure syncing. Upon initial setup, the wearable is registered to the user's account, and the wireless module is configured to detect proximity-based signals or tap gestures from other compatible devices. The wearable remains in a low-power standby mode until triggered by a potential connection event, minimizing power consumption and preserving system resources.

In step 300, once the wearable device is provisioned, the method proceeds by receiving user input that defines two or more data categories, typically “personal” and “professional.” The user accesses a control interface via the mobile application to enter various types of information. Personal data may include dating preferences, lifestyle interests, and social handles, while professional data may consist of job title, company affiliation, skills, and career achievements.

Each profile is structured into discrete data fields, and the user assigns visibility rules to each field. For example, the user may indicate that dating history is shareable only in personal mode, and their resume or portfolio is restricted to professional mode. These settings are stored in association with the user's account and may be further refined with context-specific rules, such as enabling certain fields only at certain times or in specific locations.

In step 310, the wearable device continuously scans for other compatible devices within a predefined communication range. A “connection event” occurs when a second device comes into proximity and satisfies the communication handshake protocol. This may be triggered by a tap gesture between two users, a physical bump, or simple close-range wireless pairing. The connection may also require mutual consent through a brief user interaction on the wearable or mobile app.

Once the connection event is detected, both devices verify each other's authentication credentials, and an encrypted communication session is initiated. The invention supports both symmetrical and asymmetrical authentication models, depending on the use case. For additional privacy, connection events may be accompanied by vibration, LED signals, or on-screen notifications, alerting both users that a data-sharing session is about to begin or has been successfully established.

In step 320, a secure connection is established, and the system determines the context in which the interaction is taking place, either personal or professional. This determination may be based on user input (e.g., toggling a mode in the app), geolocation data (e.g., user is at a networking event or social venue), temporal data (e.g., business hours versus weekends), or other environmental cues such as connected calendar events.

The system uses this context to activate the appropriate profile settings for the data transfer. For example, if the device detects a personal context, it activates the user's dating or social profile. If it detects a professional environment, it switches to the professional profile, ensuring that only career-related details are made available to the other party. This context-awareness reduces cognitive friction and ensures the right data is shared without requiring real-time intervention by the user.

In step 330, the system filters the available data based on the active context and the user's pre-established permission rules. The system evaluates each data field for eligibility, determining whether it should be transmitted, withheld, or delayed. This logic is executed locally on the device or within the paired application to ensure speed and security. The filtered dataset is compiled into a standardized format, such as a digital business card, profile snapshot, or interactive contact preview.

Once assembled, the filtered data is securely transmitted to the second device or application. Encryption protocols safeguard the data in transit, and optional verification steps may require mutual confirmation before either party can view the full set of shared information. This ensures that only mutually accepted exchanges result in visible data, preserving the privacy and intent of the interaction. Upon successful transfer, the system may log the exchange in the user's history, if enabled, or conclude the session with a user acknowledgment.

The wearable device is a compact, ergonomic unit designed to be worn by a user in various form factors, including but not limited to a ring, bracelet, necklace pendant, wristwatch, or clip-on badge. The device housing is composed of a durable, lightweight material suitable for prolonged contact with human skin and may be formed using plastic, metal, silicone, or combinations thereof. The outer shell may include tactile or visual cues to signal activation, such as embossed surfaces or indicator lights.

Internally, the device includes a wireless communication module configured to support short-range communication protocols such as Bluetooth Low Energy (BLE), near-field communication (NFC), or ultra-wideband (UWB). This module enables the device to detect nearby compatible devices and initiate or respond to connection events. The device further comprises a microcontroller or processor that executes local logic, including data selection, encryption routines, and interaction validation. A memory unit stores device identifiers, authentication keys, and user profile metadata as needed for real-time operation.

In some embodiments, the wearable device may include a small user interface, such as a touchscreen or LED array, to indicate the active mode (e.g., personal or professional), connection status, battery level, or incoming interaction request. Additional components may include a vibration motor for haptic feedback during connection events, a battery to power all internal electronics, and sensors such as accelerometers to detect tap gestures. The design is intended to be discreet, intuitive, and always accessible, allowing users to effortlessly engage in socially meaningful or professionally relevant exchanges without removing or interacting with their smartphone.

In one embodiment, the wearable device is implemented as a ring designed to be worn on a user's finger. The ring housing contains a miniaturized printed circuit board (PCB), a power source such as a coin-cell battery or rechargeable lithium-polymer battery, and a short-range communication module such as an NFC or Bluetooth antenna embedded circumferentially. The compactness of the ring makes it ideal for discreet use in social environments. A user can initiate a connection event simply by tapping their hand against another user's wearable ring, triggering data exchange based on pre-set permissions.

In another embodiment, the wearable device is constructed as a bracelet or wristband. This form factor offers more surface area, which allows for integration of additional components such as a touch display, biometric sensors, or multiple wireless transceivers. The bracelet may be constructed from flexible, hypoallergenic materials like silicone or thermoplastic elastomer, allowing for comfort and durability. An embedded clasp may serve a dual purpose—securing the bracelet and housing a magnetic or contact-based charging port. This variant is particularly suited for users who desire more frequent interaction with the device, such as professionals in networking environments.

A further embodiment envisions the wearable as a pendant or necklace, particularly appealing for users who prefer chest-level wearables for style or accessibility. The pendant device may have a flat, circular or geometric profile and include touch-sensitive regions to confirm pairing gestures or toggle between personal and professional modes. This version can be clipped onto chains, lanyards, or garment loops and may be ideal for conferences, events, or casual encounters where wrist-based wearables are not preferred.

The wearable may also take the form of a smartwatch or modular accessory, integrating directly with existing wearable ecosystems. In this embodiment, the invention's core functionalities—such as profile storage, communication protocol, and permission handling—may be implemented through a dedicated app that interfaces with the smartwatch hardware. Alternatively, a smartwatch band attachment may contain the communication hardware and offload processing tasks to the main watch unit. This hybrid design allows users to leverage the invention alongside their existing smart devices.

In terms of construction, the wearable device may employ multi-layer PCB assembly to accommodate compact electronic design. Key components include the microcontroller, communication chipset, memory storage (e.g., EEPROM or flash), and power management circuitry. Depending on form factor, the device may use flexible PCBs for curved or bendable housings or rigid PCBs for flat modules. Waterproof sealing, thermal insulation, and shock resistance may also be incorporated for durability and longevity.

For user interaction, some embodiments include haptic feedback mechanisms, such as a small vibration motor, that provide tactile confirmation during a successful pairing or mode switch. In embodiments with displays, an OLED or E Ink screen may be embedded on the surface of the wearable to show limited contextual information, such as the current sharing mode, recent interactions, or battery status. In screenless embodiments, LED arrays or colored indicators may be used to convey similar feedback in a lightweight and battery-efficient manner.

Charging mechanisms may vary based on design. In smaller devices, contact charging through pogo pins or magnetic docks may be preferred for compactness. Larger form factors like bracelets or pendants may support inductive wireless charging, improving water resistance and ease of use. Battery life will vary depending on transmission frequency, screen usage (if any), and power-saving features such as deep-sleep mode for inactive periods.

In some embodiments, the wearable may incorporate gesture recognition sensors such as capacitive touch strips or inertial measurement units (IMUs). These sensors can detect predefined motion patterns (e.g., double tap, swipe, or wrist rotation) to trigger a profile switch, initiate pairing, or cancel a pending interaction. This allows users to interact with the device without relying on their smartphone or external controls, making the experience more fluid and socially comfortable.

From a functional perspective, the wearable may be configured for single-user pairing or multi-user discovery mode. In single-user pairing, the device connects only to a designated contact through a verified interaction, such as a tap. In discovery mode, it broadcasts limited user metadata to nearby compatible devices, inviting others to initiate a handshake request. This mode may be especially useful in structured events like trade shows, speed-dating sessions, or collaborative workshops.

Finally, in certain embodiments, the wearable device may be integrated into fashion accessories or apparel, such as hat pins, belt buckles, or shoe tags. These integrations prioritize aesthetics while retaining full communication functionality. This diversity in wearable design allows users from various demographics, professions, and style preferences to adopt the invention without compromising their personal or professional identity.

Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

1. A system for exchanging user information, comprising:
a wearable device configured to be worn by a first user, the wearable device comprising a communication module configured to establish a connection with another wearable device worn by a second user;
a mobile application executing on a mobile device and in communication with the wearable device, the mobile application comprising a user interface for inputting and managing personal and professional user data;
wherein, upon detecting a connection event between two wearable devices, the system shares user-selected data from the first user to the second user based on one or more permission settings configured in the mobile application.

2. The system of claim 1, wherein the communication module comprises near-field communication (NFC), Bluetooth, or both.

3. The system of claim 1, wherein the connection event is initiated by a physical gesture comprising tapping two wearable devices together.

4. The system of claim 1, wherein the user interface enables the creation of a whitelist or blacklist of users for data sharing purposes.

5. The system of claim 1, wherein the mobile application includes a toggle switch to select between a personal sharing mode and a professional sharing mode.

6. The system of claim 1, wherein the wearable device comprises a display that provides a visual confirmation of a successful connection event.

7. The system of claim 1, wherein the mobile application logs each connection event and allows users to view a history of shared interactions.

8. The system of claim 1, wherein the user-selected data includes at least one of:
name, phone number, email address, dating preferences, job title, and professional background.

9. The system of claim 1, wherein the permission settings allow the user to set a time-based expiration for shared data.

10. The system of claim 1, wherein the system encrypts user data prior to transmission between devices.

11. (Withdrawn, Previously Presented) A method for context-sensitive exchange of information between first and second users, the method comprising the steps of:
receiving, from the first user, input designating different categories of data for personal and professional contexts;
detecting a connection event between a first wearable device worn by the first user and a second wearable device worn by a second user;
determining a context of the interaction;
filtering the first user's data based on the context and the first user's permission settings; and
transmitting the filtered data to the second wearable device or associated application.

12. The method of claim 11, further comprising the step of receiving confirmation from the second user before displaying the shared data.

13. The method of claim 11, wherein the context of interaction is determined based on user selection within the mobile application prior to the connection event.

14. (Withdrawn, Previously Presented) The method of claim 11, further comprising the step of automatically terminating the wireless connection after the data transfer is completed.

15. (Withdrawn, Previously Presented) The method of claim 11, wherein the step of filtering the first user's data further includes applying a privacy mask to sensitive fields.

16. The method of claim 11, wherein the connection event includes scanning a QR code generated by the wearable device.

17. (Withdrawn, Previously Presented) The method of claim 11, further comprising receiving input from the first user to designate which data fields are visible in public, semi-private, or private sharing modes.

18. (Withdrawn, Previously Presented) A wearable device for exchanging user information, comprising:
a housing configured to be worn by a user;
a wireless communication module within the housing, configured to detect and establish short-range connections with a proximate device;
a memory storing user-specific data categorized into at least a personal profile and a professional profile;
processing circuitry configured to execute instructions to:
detect the proximate device and determine whether a connection should be initiated based on user-defined rules, and selectively transmit from the personal profile or the professional profile based on one or more permission settings.

19. The wearable device of claim 18, wherein the housing is configured as a ring, bracelet, necklace, or wristwatch.

20. (Withdrawn, Previously Presented) The wearable device of claim 18, wherein the processing circuitry restricts transmission of data to devices not authenticated by the system.
